(19) United States
(12) Patent Application Publication
(10) Pub. No.: US 2020/0137310 A1
(43) Pub. Date: Apr. 30, 2020

(54) CONTROL DEVICE, PHOTOGRAPHING SYSTEM, MOVABLE BODY, AND CONTROL METHOD AND PROGRAM

(71) Applicant: SZ DJI TECHNOLOGY CO., LTD., Shenzhen (CN)

(72) Inventors: Jiayi ZHANG, Shenzhen (CN); Kenichi HONJO, Shenzhen (CN)

(21) Appl. No.: 16/723,193

(22) Filed: Dec. 20, 2019

Related U.S. Application Data
(63) Continuation of application No. PCT/CN2017/114575, filed on Dec. 5, 2017.

(30) Foreign Application Priority Data
Jun. 28, 2017 (JP) 2017-126817

(51) Int. Cl. H04N 5/232; G03B 5/00; G03B 17/56; G03B 15/00; B64D 47/08; G05D 1/00; B64C 39/02

(52) U.S. Cl. CPC H04N 5/23287; H04N 5/23258; G03B 5/00; G03B 17/561; G03B 15/006; B64C 2201/127; G05D 1/0094; B64C 39/024; G03B 2205/0007; B64C 2201/027; B64D 47/08

(57) ABSTRACT

A control device includes a memory storing a program and a processor configured to execute the program to obtain time information indicating a time at which a vibration generation mechanism of a photographing device will generate a vibration, obtain target control information of a support mechanism supporting the photographing device that corresponds to the vibration generated by the vibration generation mechanism, and operate the support mechanism according to the target control information at the time indicated by the time information.

### CROSS-REFERENCES TO RELATED APPLICATIONS

This application is a continuation of International Application No. PCT/CN2017/114575, filed on Dec. 5, 2017, which claims priority to Japanese Patent Application No. 2017-126817, filed on Jun. 28, 2017, the entire contents of both of which are incorporated herein by reference.

### TECHNICAL FIELD

The present disclosure relates to the field of photographing technology and, more particularly, to a control device, a photographing system, a movable body, a control method, and a program.

### BACKGROUND

An existing camera system determines whether a vibration component due to a mechanical shutter should be added to a vibration component detected by a vibration sensor according to a type of the shutter used at the time of shooting.

Japanese patent application publication 2007-212933.

When a photographing device supported by a rotatable support mechanism is capturing an image, the photographing device sometimes is unable to properly perform an image stabilization function to reduce blurring associated with the motion of the photographing device.

### SUMMARY

In accordance with the disclosure, there is provided a control device including a memory storing a program and a processor configured to execute the program to obtain time information indicating a time at which a vibration generation mechanism of a photographing device will generate a vibration, obtain target control information of a support mechanism supporting the photographing device that corresponds to the vibration generated by the vibration generation mechanism, and operate the support mechanism according to the target control information at the time indicated by the time information.

Also in accordance with the disclosure, there is provided a photographing system including a photographing device including a vibration generation mechanism, a support mechanism supporting the photographing device, and a control device. The control device includes a memory storing a program and a processor configured to execute the program to obtain time information indicating a time at which the vibration generation mechanism will generate a vibration, obtain target control information of the support mechanism that corresponds to the vibration generated by the vibration generation mechanism, and operate the support mechanism according to the target control information at the time indicated by the time information.

Also in accordance with the disclosure, there is provided a movable body including a propulsion system configured to cause the movable body to move, and a photographing system. The photographing system includes a photographing device including a vibration generation mechanism, a support mechanism supporting the photographing device, and a control device. The control device includes a memory storing a program and a processor configured to execute the program to obtain time information indicating a time at which the vibration generation mechanism will generate a vibration, obtain target control information of the support mechanism that corresponds to the vibration generated by the vibration generation mechanism, and operate the support mechanism according to the target control information at the time indicated by the time information.

Also in accordance with the disclosure, there is provided a control method including obtaining time information indicating a time at which a vibration generation mechanism of a photographing device will generate a vibration, obtaining target control information of a support mechanism supporting the photographing device that corresponds to the vibration generated by the vibration generation mechanism, and operating the support mechanism according to the target control information at the time indicated by the time information.

### BRIEF DESCRIPTION OF THE DRAWINGS

FIG. 1 is a schematic diagram of an unmanned aerial vehicle (UAV) and a remote operation device according to an example embodiment of the present disclosure.

FIG. 2 is a functional block diagram of a UAV according to an example embodiment of the present disclosure.

FIG. 3 is a table illustrating relationships between identification information of control information and identification information of lens assembly according to an example embodiment of the present disclosure.

FIG. 4 is a table illustrating relationships among identification information of control information, identification information of lens assembly, and identification information of gimbal according to an example embodiment of the present disclosure.

FIG. 5 is a schematic diagram illustrating communication between a photographing device and a gimbal according to an example embodiment of the present disclosure.

FIG. 6 is a schematic diagram illustrating a method of suppressing vibration caused by a shutter operation according to an example embodiment of the present disclosure.

FIG. 7 is a timing diagram illustrating a shutter operation according to an example embodiment of the present disclosure.

FIG. 8 is a schematic diagram illustrating interaction between a shutter operation and a gimbal correction operation according to an example embodiment of the present disclosure.

FIG. 9 is a hardware block diagram of a control device according to an example embodiment of the present disclosure.

### DETAILED DESCRIPTION OF THE EMBODIMENTS

Hereinafter, the present disclosure will be described in the embodiments of the present disclosure. However, the embodiments are not intended to limit the disclosure as defined in claims. Moreover, not all feature combinations described in the specification are necessary for the technical solutions of the disclosure.

Hereinafter, the present disclosure will be described in the embodiments of the present disclosure. However, the embodiments are not intended to limit the invention as defined in claims. Moreover, not all feature combinations described in the specification are necessary for the technical solutions of the disclosure. It should be understood by those skilled in the art that various modifications and improvements can be made to the embodiments described below. It can be understood from the description of the claims that such modifications or improvements are within the scope of the present disclosure.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

The various embodiments of the present disclosure can be described with reference to flowcharts and block diagrams. The blocks in the block diagram may represent (1) a stage or a step of a process of performing an operation, or (2) a circuit of a device for performing an operation. The specially designated stage or circuit may be implemented by a programmable circuit and/or a processor. The specially designated circuit may include a digital and/or analog hardware circuit, and may include an integrated circuit (IC) and/or a discrete circuit. The programmable circuit may include a reconfigurable circuit. The reconfigurable circuit may include a logic AND, a logic OR, a logic XOR, a logic NAND, a logic NOR, other logic operators, a flip-flop, a register, a filed programmable gate array (FPGA), a programmable logic array (PLA), and other memory circuits.

A computer-readable medium may include any tangible device that can store instructions to be executed by a suitable device. As s result, the computer-readable medium storing the instructions is a product containing executable instructions. The executable instructions are means for performing the operations designated in the flowcharts or the block diagrams. For illustrative purposes, the computer-readable medium may include an electronic storage medium, a magnetic storage medium, an optical storage medium, an electromagnetic storage medium, or a semiconductor storage medium, etc. For example, the computer-readable medium may include a floppy (registered trade mark) disk, a soft magnetic disk, a hard disk, a random-access memory (RAM), a read-only memory (ROM), an erasable programable read-only memory (EPROM), an electrically erasable programable read-only memory (EEPROM), a static random-access memory (SRAM), a micro optical read-only memory (CD-ROM), a digital versatile disc (DVD), a Blu-ray (registered trade mark) disk, a memory stick, or an intertied circuit card, etc.

The computer-readable instructions may include any of source code or object code described in any combination of one or more programming languages. The source code or the object code includes an existing procedural programming language. The existing procedural programming language may be assembly instructions, instruction set architecture (ISA) instructions, machine instructions, machine dependent instructions, microcode, firmware instructions, state setting data, object-oriented programming languages such as Smalltalk, JAVA®, C++, C programming language, or similar programming languages. The computer-readable instructions may be supplied locally or through a local area network (LAN) or a wide area network (WAN) such as Internet to a general-purpose computer, a special-purpose computer, a processor in other programmable data processing device, or a programmable circuit. The processor or the programmable circuit may be the means for executing the computer-readable instructions to perform the operations designated in the flowcharts or the block diagrams. For example, the processor may be a computer processor, a processing unit, a microprocessor, a digital signal processor, a controller, or a microcontroller, etc.

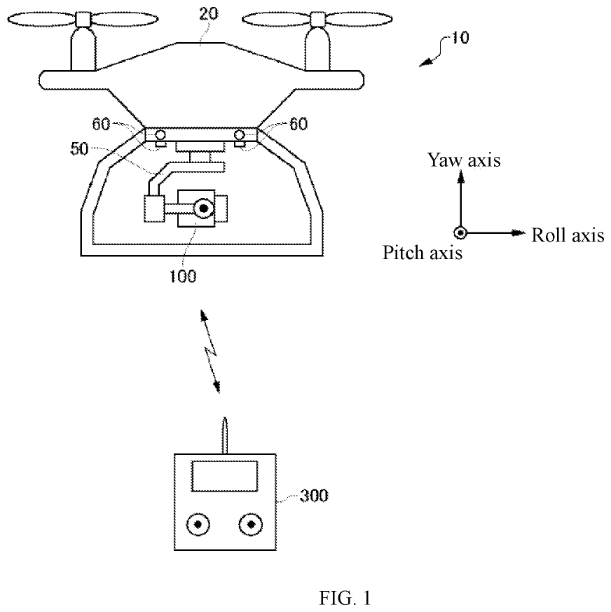

FIG. 1 is a schematic diagram of an unmanned aerial vehicle (UAV) and a remote operation device according to an example embodiment of the present disclosure. As shown in FIG. 1, the UAV 10 includes a UAV main body 20, a gimbal 50, a plurality of photographing devices 60, and a photographing device 100. The gimbal 50 and the photographing device 100 are one example of a photographing system. The UAV 10 is one example of a movable body propelled by a propulsion system. In addition to the UAV, the concept of the movable body also includes other flying objects such as an aircraft moving in the air, a vehicle moving on the ground, or a vessel moving on the water, etc.

The UAV main body 20 includes a plurality of rotors. The plurality of rotors is one example of propulsion systems. The UAV main body 20 can cause the UAV 10 to fly by controlling the rotation of the plurality of rotors. For example, the UAV main body 20 includes four rotors to cause the UAV 10 to fly. The number of the rotors may not be limited to four. Further, the UAV 10 may be a rotor-less fixed-wing aircraft.

The photographing device 100 is a camera that photographs a target object within an expected photographing range. The gimbal 50 supports the photographing device 100 by changing the attitude of the photographing device 100. The gimbal 50 supports the photographing device 100 by rotating the photographing device 100. The gimbal 50 is one example of supporting mechanisms. For example, the gimbal 50 supports the photographing device 100 by using an actuator to rotate the photographing device 100 around a pitch axis. The gimbal 50 supports the photographing device 100 by using the actuator to rotate the photographing device 100 around a roll axis and a yaw axis, respectively. The gimbal 50 changes the attitude of the photographing device 100 by rotating the photographing device 100 around at least one of the yaw axis, the pitch axis, or the roll axis.

The plurality of photographing devices 60 can be sensing cameras that photograph surroundings of the UAV 10 for controlling flying of the UAV 10. Two photographing devices 60 are disposed at the front of the UAV 10, that is, facing toward the front side. Two additional photographing devices 60 are disposed at the bottom side of the UAV 10. The two front side photographing devices 60 are paired and function as a three-dimensional (3D) camera. The two bottom side photographing devices 60 are also paired and functioned as the 3D camera. Images photographed by the plurality of photographing devices 60 are combined to generate 3D spatial data surrounding the UAV 10. The number of the photographing devices 60 mounted at the UAV 10 is not limited to four. The UAV 10 includes at least one photographing device 60. The UAV 10 may include at least one photographing device 60 at each of the front side, the rear side, the left side, the right side, the bottom side, and the top side of the UAV 10. A configurable viewing angle of each of the plurality of photographing devices 60 may be greater than a configurable view angle of the photographing device 100. That is, the photographing range of each photographing device 60 is greater than the photographing range of the photographing device 100. Each photographing device 60 may include a fixed focus lens or a fisheye lens.

As shown in FIG. 1, the remote operation device 300 communicates with the UAV 10 to remotely control the operation of the UAV 10. The remote operation device 300 may communicate with the UAV 10 wirelessly. The remote operation device 300 sends driving information to the UAV 10. The driving information includes various driving instructions related to movements of the UAV 10, such as ascending, descending, accelerating, decelerating, advancing, retreating, and rotating, etc. For example, the driving information includes the instruction causing the UAV 10 to ascend. The driving information may indicate a target height of the UAV 10. In response to the instruction, the UAV 10 moves to the target height as indicated by the driving information received from the remote operation device 300. The driving information includes the ascending instruction causing the UAV 10 to ascend. In response to the ascending instruction, the UAV 10 ascends. In response to the ascending instruction, the UAV 10 may not ascend if the target height as indicated by the driving information received from the remote operation device 300 has already been reached.

In the UAV 10 configured as described above, because the photographing device 100 and the gimbal 50 separately perform vibration correction (or image stabilization) function, the vibration of the photographing device 100 sometimes may not be properly corrected. As a result, the photographing device 100 may not capture an expected image. For example, if the shutter of the photographing device 100 mounted at the UAV 10 is operated, the UAV 10 sometimes vibrates due to the shutter operation, thereby causing the photographing device 100 unable to capture the expected image.

Therefore, in some embodiments, the gimbal 50 properly performs the vibration correction function in response to the shuttering operation of the photographing device 100, thereby suppressing the vibration of the photographing device 100.

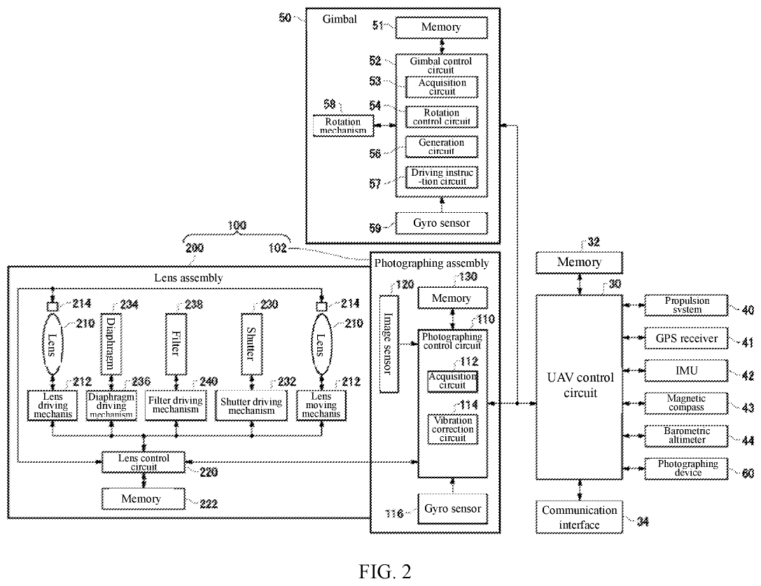

FIG. 2 is a functional block diagram of the UAV 10 according to an example embodiment of the present disclosure. As shown in FIG. 2, the UAV 10 includes a UAV control circuit 30 (UAV controller), a memory 32, a communication interface 34, a propulsion system 40, a GPS receiver 41, an inertial measurement unit (IMU) 42, a magnetic compass 43, a barometric altimeter 44, a gimbal 50, one or more photographing devices 60, and a photographing device 100.

The communication interface 34 communicates with the remote operation device 300 and other devices. The communication interface 34 receives instruction information. The instruction information includes various instructions from the remote operation device 300 to the UAV control circuit 30. The memory 32 stores programs for the UAV control circuit 30 to control the propulsion system 40, the GPS receiver 41, the IMU 42, the magnetic compass 43, the barometric altimeter 44, the gimbal 50, the one or more photographing devices 60, and the photographing device 100. The memory 32 is a computer-readable storage medium including at least one of an SRAM, a DRAM, an EPROM, an EEPROM, or a USB flash memory. The memory 32 can be disposed inside the UAV main body 20. The memory 32 may be configured to be removable from the UAV main body 20.

The UAV control circuit 30 controls the flying of the UAV 10 and the operation of the photographing device 100 according to the programs stored in the memory 32. The UAV control circuit 30 includes a microprocessor such as a CPU or an MPU, or a microcontroller such as an MCU. The UAV control circuit 30 controls the flying of the UAV 10 and the operation of the photographing device 100 according to the instructions received from the remote operation device 300 through the communication interface 34. The propulsion system 40 propels the UAV 10. The propulsion system 40 includes a plurality of rotors and a plurality of motors for driving the plurality of rotors to rotate. According to the driving instructions from the UAV control circuit 30, the propulsion system 40 uses the plurality of motors to drive the plurality of rotors to rotate, thereby causing the UAV 10 to fly.

The UAV control circuit 30 analyzes a plurality of images photographed by the plurality of sensing photographing devices 60, thereby identifying the environment around the UAV 10. According to the environment around the UAV 10, the UAV control circuit 30 controls the flying, such as avoiding obstacles. Based on the plurality of images photographed by the plurality of photographing devices 60, the UAV control circuit 30 generates the 3D spatial data surrounding the UAV 10 and controls the flying based on the 3D spatial data.

The GPS receiver 41 receives a plurality of signals indicating the time of transmitting from a plurality of GPS satellites. Based on the plurality of received signals, the GPS receiver 41 calculates a position of the GPS receiver 41, that is, a position of the UAV 10. The IMU 42 detects the attitude of the UAV 10. The attitude of the UAV 10 detected by the IMU 42 includes accelerations in three axes including a front-rear axis, a left-right axis, and a top-bottom axis, and angular velocities in three axial directions of pitch, roll, and yaw axes. The magnetic compass 43 detects orientation of the front of the UAV 10. The barometric altimeter 44 detects the flying height of the UAV 10. The barometric altimeter 44 detects an air pressure around the UAV 10 and converts the detected air pressure into the height, thereby detecting the flying height.

The photographing device 100 includes a photographing assembly 102 and a lens assembly 200. The lens assembly 200 is one example of lens devices. The photographing assembly 102 includes an image sensor 120, a photographing control circuit 110 (photographing controller), a gyro sensor 116, and a memory 130. The image sensor 120 may be a CCD or CMOS image sensor. The image sensor 120 outputs image data of optical images captured by a plurality of lenses 210 to the photographing control circuit 110. The photographing control circuit 110 includes a microprocessor such as a CPU or an MPU, or a microcontroller such as an MCU. The photographing control circuit 110 controls the photographing device 100 according to an operation instruction for the photographing device 100 received from the UAV control circuit 30. The gyro sensor 116 detects the vibration of the photographing device 100. The memory 130 is a computer-readable storage medium including at least one of an SRAM, a DRAM, an EPROM, an EEPROM, or a USB flash memory. The memory 130 stores programs for the photographing control circuit 110 to control the image sensor 120. The memory 130 can be disposed inside the housing of the photographing device 100. The memory 130 may be configured to be removable from the housing of the photographing device 100.

The lens assembly 200 includes a plurality of lenses 210, a plurality of lens driving mechanisms 212, and a lens control circuit 220 (lens controller). The plurality of lenses 210 may function as a zoom lens, a variable focus lens, or a fixed focus lens. Some or all of the plurality of lenses 210 are configured to move along an optical axis. The lens assembly 200 may be detachable from the photographing assembly 102. The plurality of lens driving mechanisms 212 move some or all of the plurality of lenses 210 along the optical axis. According to a lens control instruction from the photographing assembly 102, the lens control circuit 220 drives the plurality of lens driving mechanisms 212 to make one or more lenses move along the optical axis. The lens control instruction includes, for example, a zoom control instruction and a focus control instruction.

The lens assembly 200 also includes a memory 222, a position sensor 214, a diaphragm 234, a diaphragm driving mechanism 236, a filter 238, a filter driving mechanism 240, a shutter 230, and a shutter driving mechanism 232.

According to the lens control instruction from the photographing assembly 102, the lens control circuit 220 drives the plurality of lens driving mechanisms 212 to make one or more lenses move along the optical axis. Some or all of the plurality of lenses 210 moves along the optical axis. By driving at least one of the plurality of lenses 210 to move along the optical axis, the lens control circuit 220 executes at least one of the zoom operation and the focus operation. The position sensor 214 detects the positions of the plurality of lenses 210. The position sensor 214 detects the current zoom position or focus position.

The diaphragm 234 adjusts an amount of incident light shined on the image sensor 120. The diaphragm 234 includes at least one aperture blade. The diaphragm driving mechanism 236 includes an actuator. The actuator may be an electromagnetic actuator. The electromagnetic actuator may be an electromagnet or a solenoid. The diaphragm driving mechanism 236 receives instructions from the lens control circuit 220 to drive the actuator and to adjust how much the plurality of aperture blades overlap, thereby adjusting a size of the diaphragm opening (the aperture).

The filter 238 reduces the amount of incident light passing through the plurality of lenses 210 or blocks light of certain wavelength(s). The filter 238 includes at least one of a neutral density (ND) filter or an infrared (IR) cut-off filter. The filter driving mechanism 240 includes an actuator. The actuator may be an electromagnetic actuator. The electromagnetic actuator may be an electromagnet or a solenoid. The filter driving mechanism 240 receives instructions from the lens control circuit 220 to drive the actuator, such that the filter 238 moves between a first position that allows the incident light to pass through and a second position that removes a portion of the incident light at a certain wavelength or attenuates the incident light.

The shutter 230 includes at least one aperture blade. The shutter driving mechanism 232 includes an actuator. The actuator may be an electromagnetic actuator. The electromagnetic actuator may be an electromagnet or a solenoid. The shutter driving mechanism 232 receives instructions from the lens control circuit 220 to drive the actuator. As such, a speed of overlapping a plurality of aperture blades can be adjusted, thereby switching between passing through the incident light and cutting off the incident light at an expected speed.

The memory 222 stores a plurality of control values for the plurality of lens driving mechanisms 212 to move the plurality of lenses 210. The memory 222 may be at least one of an SRAM, a DRAM, an EPROM, an EEPROM, or a USB flash memory.

In some embodiments, the lens assembly 200 includes the shutter 230, the filter 238, the diaphragm 234, the plurality of lenses 210. When the plurality of lens driving mechanisms 212 drive the plurality of lenses 210 to move, the photographing device 100 sometimes vibrates. In some embodiments, before the operations on the shutter 230, the filter 238, the diaphragm 234, the plurality of lenses 210, and the plurality of lens driving mechanisms 212 take place, the gimbal 50 obtains vibration information in advance. The gimbal 50 also obtains in advance time information of the operations taking place on the shutter 230, the filter 238, the diaphragm 234, the plurality of lenses 210, and the plurality of lens driving mechanisms 212. Moreover, based on the vibration information and the associated time information, the gimbal 50 operates to suppress the vibration of the photographing device 100. In this case, the shutter 230, the filter 238, the diaphragm 234, the plurality of lenses 210, and the plurality of lens driving mechanisms 212 are examples of vibration-causing structures. Hereinafter, the shutter 230 will be described as an example of the vibration-causing structures.

The gimbal 50 includes a memory 51, a gimbal control circuit 52, a gyro sensor 59, and a rotating mechanism 58. The gimbal control circuit 52 includes a microprocessor such as a CPU or an MPU, or a microcontroller such as an MCU. The gyro sensor 59 detects the vibration of the gimbal 50. The rotating mechanism 58 uses actuators to rotatably support the photographing device 100 to rotate around a roll axis and a yaw axis respectively. The rotating mechanism 58 may rotatably support the photographing device 100 to rotate around at least one of the yaw axis, the pitch axis, or the roll axis.

The gimbal control circuit 52 includes an acquisition circuit 53, a rotation control circuit 54, and a generation circuit 56. The acquisition circuit 53 acquires time information when the shutter 230 causes the vibration. The acquisition circuit 53 acquires the time information from the photographing device 100. The acquisition circuit 53 acquires control information of the gimbal 50. The control information of the gimbal 50 corresponds to the vibration caused by the shutter 230. The acquisition circuit 53 is one example of a first acquisition circuit, a second acquisition circuit, and a third acquisition circuit. The rotation control circuit 54 controls the gimbal 50 according to the control information at the time indicated in the time information. The rotation control circuit 54 is one example of control circuits.

In some embodiments, the memory 222 of the lens assembly 200 stores in advance the vibration information about the vibration caused by the shutter 230. Further, the acquisition circuit 53 acquires the vibration information from the lens assembly 200. Based on the vibration information acquired by the acquisition circuit 53, the generation circuit 56 generates the control information. The acquisition circuit 53 acquires the control information generated by the generation circuit 56. For example, before the photographing device 100 is shipped, the shutter 230 can be operated while the photographing device 100 is mounted at the gimbal 50 and the gyro sensor 116 is used to detect the vibration of the photographing device 100. The vibration information is generated based on a signal detected by the gyro sensor 116. The vibration information is registered in advance in the memory 222.

In some embodiments, the memory 222 does not store the vibration information. Instead, the memory 222 stores the control information of the gimbal corresponding to the vibration information. In this case, the acquisition circuit 53 may acquire the control information from the memory 222. The control information includes a driving instruction for driving a motor of the gimbal 50.

The vibration information or the driving information may also be stored in the memory 51. In this case, the acquisition circuit 53 may acquire the vibration information or the driving information from the memory 51. The acquisition circuit 53 may also acquire the vibration information or the driving information corresponding to the vibration of the lens assembly 200 from a server connected to the network.

In some embodiments, in association with respective identification information of the plurality of lens assemblies 200, i.e., a plurality of detachable lenses, the memory 51 can store the control information of the gimbal 50 corresponding to the vibration caused by the respective shutters 230 of the plurality of lens assemblies 200. In this case, the acquisition circuit 53 acquires the identification information of the lens assembly 200 of the photographing device 100 from the lens assembly 200. Moreover, the acquisition circuit 53 acquires the control information corresponding to the identification information acquired from the memory 51.

In accordance with the respective identification information of the plurality of lens assemblies, the memory 51 stores the vibration information of the vibration caused by the respective shutter 230 of the plurality of lens assemblies 200. In this case, the acquisition circuit 53 acquires the vibration information from the memory 51 corresponding to the identification information of the lens assembly 200 acquired from the lens assembly 200. The generation circuit 56 generates the control information of the gimbal 50 corresponding to the vibration information acquired from the memory 51.

Depending on combination of the lens assembly 200 and the gimbal 50, vibration status of the photographing device 100 changes. That is, the vibration status of the photographing device 100 changes depending on the combination of a type of the detachable lens assembly 200 and a type of the gimbal 500.

Therefore, in association with the respective identification information of the plurality of lens assemblies 200 and the respective identification information of a plurality of gimbals 50, the memory 32 of the UAV 10, for example, can store the vibration information of the vibration caused by the respective shutters 230 of the plurality of lens assemblies 200. The acquisition circuit 53 acquires the identification information of the lens assembly 200 from the lens assembly 200 of the photographing device 100, and acquires the identification information of the gimbal 50 that supports the photographing device 100 from the memory 51. The acquisition circuit 53 acquires the vibration information corresponding to the identification information of the lens assembly 200 and the identification information of the gimbal 50 from the memory 32. The generation circuit 56 generates the control information based on the vibration information acquired by the acquisition circuit 53.

In association with the respective identification information of the plurality of lens assemblies and the respective identification information of the plurality of gimbal 50, the memory 32 can store the respective control information of the plurality of gimbal 50 corresponding to the vibration caused by the respective shutter 230 of the plurality of lens assemblies 200. In this case, the acquisition circuit 53 acquires the vibration information from the memory 32 corresponding to the identification information of the lens assembly 200 and the identification information of the gimbal 50.

The memory 130 of the photographing assembly 102 also stores the vibration information of the vibration caused by the shutter 230 or the control information of the gimbal 50 corresponding to the vibration information.

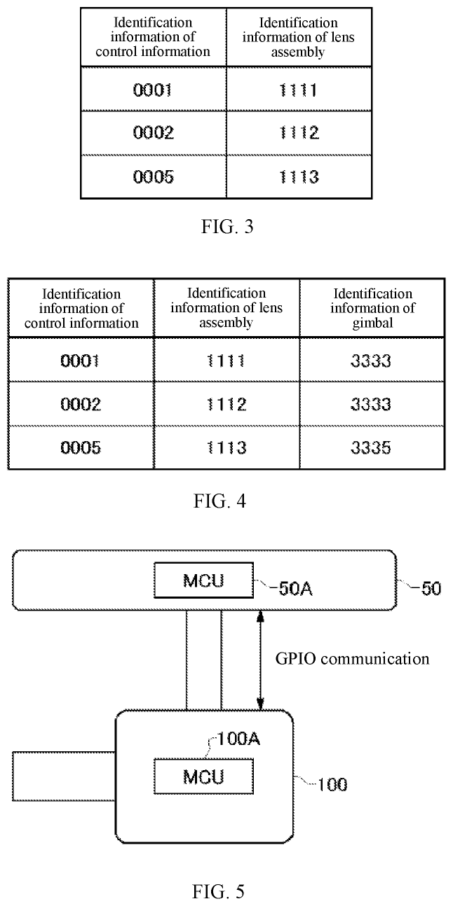

FIG. 3 is a table illustrating correspondence relationships between identification information of control information and identification information of lens assembly according to an example embodiment of the present disclosure. The memory 51 stores the table. The acquisition circuit 53 acquires the identification information of the control information from the table corresponding to the identification information of the lens assembly 200 acquired from the lens assembly 200. The acquisition circuit 53 also acquires the control information from the memory 51 corresponding to the identification information of the control information acquired from the table.

FIG. 4 is a table illustrating relationships among identification information of control information, identification information of lens assembly, and identification information of gimbal according to an example embodiment of the present disclosure. The memory 32 stores the table. The acquisition circuit 53 acquires the identification information of the control information from the table corresponding to the identification information of the lens assembly 200 acquired from the lens assembly 200 and the identification information of the gimbal 50 acquired from the memory 51. The acquisition circuit 53 also acquires the control information from the memory 51 corresponding to the identification information of the control information acquired from the table.

The acquisition circuit 53 acquires the time information of the operation taking place on the shutter 230 from the photographing device 100. The rotation control circuit 54 controls the gimbal 50 according to the control information acquired by the acquisition circuit 53 at the time indicated in the time information. As such, the vibration of the photographing device 100 caused by the operation of the shutter 230 is avoided.

The gimbal control circuit 52 further controls the rotation of the gimbal 50 through a feedback control according to signals detected by the gyro sensor 59 and the gyro sensor 116. That is, the gimbal control circuit 52 performs a feedforward control based on the control information and a feedback control based on the signals detected by the gyro sensor 59 and the gyro sensor 116.

The gyro control circuit 52 also includes a driving instruction circuit 57. At a pre-determined time before the operation of the shutter 230 takes place, the driving instruction circuit 57 instructs the photographing device 100 to drive the shutter 230. For example, the gimbal control circuit 52 instructs the photographing device 100 to drive the shutter 230 at a calibration time before the UAV 10 takes off. The generation circuit 56 acquires the detected signal corresponding to the vibration of the photographing device 100 from the gyro sensor 116 of the photographing assembly 102, generates the control information of the gimbal 50 based on the detected signal at the calibration time before the UAV 10 takes off, and stores the control information in the memory 51.

In some scenarios, the gimbal 50 may not completely suppress the vibration of the shutter 230. In this case, the vibration correction of the photographing device 100 is used to remove a residual component of the vibration. The photographing control circuit 110 includes an acquisition circuit 112 and a vibration correction circuit 114. The acquisition circuit 112 acquires correction information for the residual component of the vibration. The residual component of the vibration is a component that cannot be suppressed by controlling the gimbal 50 based on the control information. The acquisition circuit 112 acquires the correction information stored in the memory 222 or the memory 130. The vibration correction circuit 114 corrects the vibration based on the correction information at the time the operation of the shutter 230 takes place. The vibration correction circuit 114 optically corrects the vibration. That is, the vibration correction circuit 114 drives at least one of the plurality of lenses 210 or the image sensor 120 based on the correction information at the time the operation of the shutter 230 takes place, thereby correcting the vibration based on the correction information. Thus, the residual component of the vibration that cannot be suppressed by controlling the gimbal 50 is removed.

In some embodiments, the correction information is generated based on the measurement of the lens assembly 200 before shipment. That is, the shutter 230 can be operated when the photographing device 100 is mounted at the gimbal 50, and the vibration correction of the gimbal 50 is performed based on the control information. In this case, the gyro sensor 116 detects the residual component of the vibration of the photographing device 100. Based on the signal detected by the gyro sensor 116, the photographing control circuit 110 generates the correction information, and registers the correction information in the memory 222 in advance. For example, the gimbal 50 corrects the vibration of the photographing device 100 caused by the shutter 230 in a first frequency band, and the photographing device 100 corrects the residual component of the vibration in a second frequency band. By controlling the attitude of the photographing device 100, the gimbal 50 corrects the component of the vibration of the photographing device 100 caused by the shutter 230 in the first frequency band. The photographing device 100 also optically corrects the component of the vibration in the second frequency band, which is lower than the first frequency band. The first frequency band is wider than the second frequency band.

As shown in FIG. 5, the MCU 100A of the photographing device 100 communicates with the MCU 50A of the gimbal 50 through a general-purpose input/output (GPIO) interface. The MCU 100A functions as the photographing control circuit 110, and the MCU 50A functions as the gimbal control circuit 52.

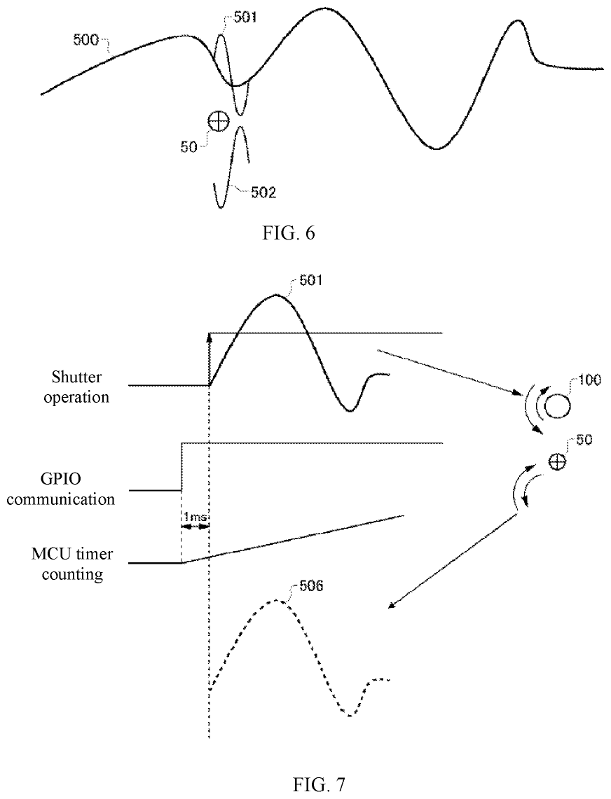

As shown in FIG. 6, through the gyro sensor 116, the gimbal 50 detects the vibration of the photographing device 100. To suppress the vibration 500, the gimbal 50 uses the feedback control to suppress the vibration of the photographing device 100. Moreover, the gimbal 50 uses the feedforward control to apply the vibration 502 for canceling the vibration 501 of the photographing device 100 at the time the operation of the shutter 230 takes place.

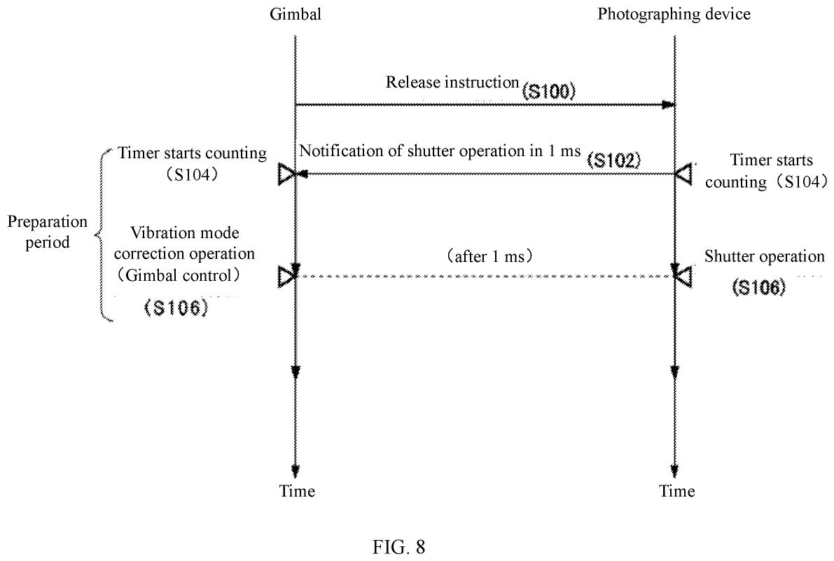

As shown in FIG. 7 and FIG. 8, the gimbal 50 receives a release instruction (S100) for the photographing device 100 through the UAV control circuit 30 from the remote operation device 300. After receiving the release instruction, the photographing device 100 uses the GPIO communication to notify the gimbal 50 of time information indicating the time at which the shutter 230 operates (S102). For example, the photographing device 100 notifies the gimbal 50 that the shutter 230 will operate in 1 ms. After the notification is sent, the timers of the MCU 50A of the gimbal 50 and the MCU 100A of the photographing device 100 both start counting (S104). After the timers end counting for 1 ms, the operation of the shutter 230 of the photographing device 100 takes place, and the gimbal 50 drives the photographing device 100 to vibrate according to the control information corresponding to the vibration of the shutter 230. The gimbal 50 operates in a pre-determined vibration mode to perform the correction operation. Through controlling the gimbal 50, the vibration 501 of the photographing device 100 caused by the operation of the shutter 230 is cancelled as indicated by symbol 506.

As described above, the photographing system according to the embodiments of the present disclosure allows the photographing device 100 rotatably supported by the gimbal 50 to appropriately perform the vibration correction of the photographing device 100 during the shooting.

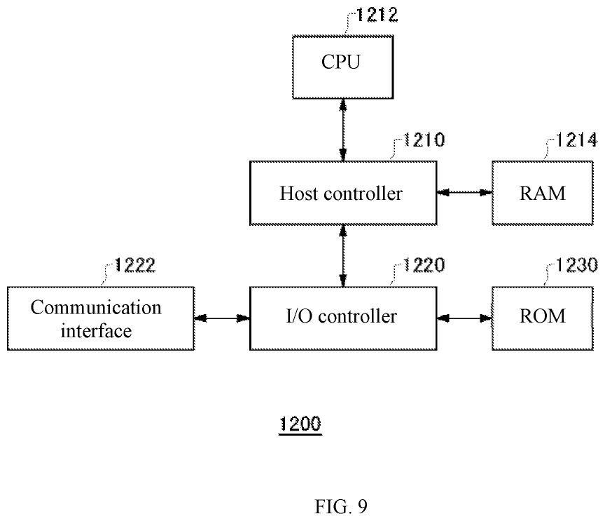

FIG. 9 is a hardware block diagram of a control device according to an example embodiment of the present disclosure. FIG. 9 shows an example computer 1200 that implements various aspects of the present disclosure, in whole or in part. The program stored in the computer 1200 enables the computer 1200 to operate as the device provided by the embodiments of the present disclosure or function as one or more circuits of the device. In some embodiments, the program enables the computer 1200 to execute the operation or function as one or more circuits. The program enables the computer 1200 to execute the process or part of the process of the embodiments of the present disclosure. To execute some or all related operations in the flowchart and the block diagram specified in the specification, the program may be executed by a CPU 1212.

In some embodiments, the computer 1200 includes the CPU 1212 and a RAM 1214. The CPU 1212 and the RAM 1214 are connected to each other by a host controller 1210. The computer 1200 also includes a communication interface 1222 and an input/output circuit. The communication interface 1222 and the input/output circuit are connected to the host controller 1210 through an input/output controller 1220. The computer 1200 also includes a ROM 1230. The CPU 1212 executes the program stored in the ROM 1230 and the RAM 1214 to control other circuits.

The communication interface 1222 communicates with other electronic devices through a network. A hard disk drive can store the program and the data for use by the CPU 1212 of the computer 1200. The ROM 1230 stores a boot program to be executed by the computer at the time of activation and/or a program dependent on the hardware of the computer 1200. The program may be provided through computer-readable storage media such as CD-ROM, USB memory or IC card, or through the network. The program may be installed in the computer-readable storage media such as the RAM 1214 or the ROM 1230 for execution by the CPU 1212. The program specifies information processing to be retrieved by the computer 1200 for coordination between the program and various types of hardware resources. The device or the method may be constructed by using the computer 1200 to implement the information operation or the information processing.

For example, when the computer 1200 communicates with an external device, the CPU 1212 may execute a communication program loaded in the RAM 1214. Based on the processing described in the communication program, the CPU 1212 instructs the communication interface to perform the communication processing. Under the control of the CPU 1212, the communication interface 1222 retrieves transmission data stored in a transmission buffer provided by the storage medium such as the RAM 1214 or the USB memory, transmits the retrieved transmission data to the network, or writes received data received from the network into a receiving buffer provided by the storage medium.

Moreover, the CPU 1212 may retrieve some or all files or databases stored in an external storage medium such as the USB memory, write into the RAM 1214, and perform various types of processing on the data stored in the RAM 1214. Then, the CPU 1212 may write the processed data back into the external storage medium.

Various types of information such as programs, data, tables, and databases are stored in the storage medium for performing the information processing. The CPU 1212 may execute various types of processing on the data retrieved from the RAM 1214 and write the results back into the RAM 1214. The various types of processing include, but are not limited to, various types of operations, information processing, condition determination, conditional branch, unconditional branch, information retrieval/substitution, that are described in the present disclosure and specified in the program instructions. Moreover, the CPU 1212 may retrieve the information in files and databases in the storage medium. For example, when the storage medium stores a plurality of entries of attribute values of a first attribute related to the attribute values of a second attribute respectively, the CPU 1212 may retrieve an entry from the plurality of entries satisfying a certain condition specified in the attribute values of the first attribute, retrieve the attribute values of the second attribute stored in the entry, and obtain the attribute values of the second attribute related to the first attribute satisfying the pre-determined condition.

The above described program or software may be stored in the computer 1200 or in a computer-readable storage medium coupled to the computer 1200. Moreover, the storage medium such as a hard disk or a RAM provided by a server system connecting to a special-purpose communication network or Internet may be used as the computer-readable storage medium. As such, the program may be provided to the computer 1200 through the network.

It should be noted that the processes, the procedures, the steps, and the stages, etc. in the devices, the systems, the program, and the method in the claims, the specification, and the drawings may be executed in any order unless indicated by terms such as “before” and “previous,” etc., or output of a preceding process is used in a succeeding process. For the convenience of illustration, terms such as “first” and “next,” etc., are used for describing a flowchart or procedure in the claims, the specification, and the drawings. However, it does not mean that the flowchart or the procedure must be implemented in this order.

The foregoing descriptions are merely some implementation manners of the present disclosure, but the scope of the present disclosure is not limited thereto. While the embodiments of the present disclosure have been described in detail, those skilled in the art may appreciate that the technical solutions described in the foregoing embodiments may be modified or equivalently substituted for some or all the technical features. And the modifications or substitutions do not depart from the scope of the technical solutions of the embodiments of the present disclosure.

The numerals and labels in the drawings are summarized below.
10 UAV
20 UAV main body
30 UAV control circuit
32 Memory
34 Communication interface
40 Propulsion system
41 GPS receiver
42 IMU
43 Magnetic compass
44 Barometric altimeter
50 Gimbal
51 Memory
52 Gimbal control circuit
53 Acquisition circuit
54 Rotation control circuit
56 Generation circuit
57 Driving instruction circuit
58 Rotating mechanism
59 Gyro sensor
60 Photographing device
100 Photographing device
102 Photographing assembly
110 Photographing control circuit
112 Acquisition circuit
114 Vibration correction circuit
116 Gyro sensor
120 Image sensor
130 Memory
200 Lens assembly
210 Lens
212 Lens driving mechanism
214 Position sensor
220 Lens control circuit
222 Memory
230 Shutter
232 Shutter driving mechanism
234 Diaphragm
236 Diaphragm driving mechanism
238 Filter
240 Filter driving mechanism
300 Remote operation device
1200 Computer
1210 Host controller
1212 CPU
1214 RAM
1220 Input/output controller
1222 Communication interface
1230 ROM

What is claimed is:

1. A control device comprising:
a memory storing a program; and
a processor configured to execute the program to:
obtain time information indicating a time at which a vibration generation mechanism of a photographing device will generate a vibration;
obtain target control information of a support mechanism supporting the photographing device, the target control information corresponding to the vibration generated by the vibration generation mechanism; and
operate the support mechanism according to the target control information at the time indicated by the time information.

2. The control device of claim 1, wherein the processor is further configured to execute the program to:
obtain vibration information corresponding to the vibration from a memory of the photographing device; and
generate the target control information based on the vibration information.

3. The control device of claim 1, wherein a lens assembly attached to the photographing device includes the vibration generation mechanism.

4. The control device of claim 3, wherein the processor is further configured to obtain the target control information from a memory of the lens assembly.

5. The control device of claim 3, wherein:
the memory further stores correspondence relationships between:
identifications of multiple detachable lens assemblies each including a vibration generation mechanism configured to generate vibration, and
multiple pieces of control information of the support mechanism; and
the processor is further configured to execute the program to obtain, from the memory, one of the multiple pieces of control information that corresponds to an identification of the attached lens assembly as the target control information.

6. The control device of claim 3, wherein:
the memory further stores correspondence relationships between:
identifications of multiple detachable lens assemblies each including a vibration generation mechanism configured to generate vibration, and
multiple pieces of vibration information; and
the processor is further configured to execute the program to:
obtain, from the memory, one of the multiple pieces of vibration information that corresponds to an identification of the attached lens assembly; and
generate the target control information based on the obtained one of the multiple pieces of vibration information.

7. The control device of claim 3, wherein:
the memory further stores correspondence relationships among:
identifications of multiple detachable lens assemblies each including a vibration generation mechanism configured to generate vibration,
identifications of multiple support mechanisms, and
multiple pieces of vibration information; and
the processor is further configured to execute the program to:
obtain, from the memory, one of the multiple pieces of vibration information that corresponds to an identification of the attached lens assembly and an identification of the support mechanism; and
generate the target control information based on the obtained one of the multiple pieces of vibration information.

8. The control device of claim 3, wherein:
the memory further stores correspondence relationships among:
identifications of multiple detachable lens assemblies each including a vibration generation mechanism configured to generate vibration,
identifications of multiple support mechanisms, and
multiple pieces of control information; and
the processor is further configured to execute the program to obtain, from the memory, one of the multiple pieces of control information that corresponds to an identification of the attached lens assembly and an identification of the support mechanism as the target control information.

9. The control device of claim 1, wherein the processor is further configured to execute the program to:
obtain vibration information that corresponds to the vibration from a memory of the photographing device; and
generate the target control information based on the vibration information.

10. The control device of claim 1, wherein the processor is further configured to execute the program to obtain the target control information from a memory of the photographing device.

11. The control device of claim 1, wherein the processor is further configured to execute the program to control the support mechanism according to the target control information and a signal detected by a sensor detecting the vibration of the photographing device.

12. The control device of claim 1, wherein the processor is further configured to execute the program to:
instruct the photographing device to drive the vibration generation mechanism at a pre-determined time;
generate the target control information according to a signal from a sensor detecting vibration of the photographing device at the pre-determined time; and
store the target control information in the memory.

13. The control device of claim 1, wherein the processor is further configured to execute the program to obtain the time information from the photographing device.

14. The control device of claim 1, wherein the vibration generation mechanism includes at least one of a shutter, a filter, a diaphragm, a lens, or a lens driving mechanism.

15. A photographing system comprising:
a photographing device including a vibration generation mechanism;
a support mechanism supporting the photographing device; and
a control device including:
a memory storing a program; and
a processor configured to execute the program to:
obtain time information indicating a time at which the vibration generation mechanism will generate a vibration;
obtain target control information of the support mechanism that corresponds to the vibration generated by the vibration generation mechanism; and
operate the support mechanism according to the target control information at the time indicated by the time information.

16. The photographing system of claim 15, wherein the processor is further configured to execute the program to:
acquire correction information for a residual component of the vibration, the residual component being not able to be suppressed by operating the support mechanism according to the target control information; and
perform a vibration correction according to the correction information at the time indicated by the time information.

17. A movable body comprising:
a propulsion system configured to cause the movable body to move; and
the photographing system of claim 15.

18. A control method comprising:
obtaining time information indicating a time at which a vibration generation mechanism of a photographing device will generate a vibration;
obtaining target control information of a support mechanism supporting the photographing device, the target control information corresponding to the vibration generated by the vibration generation mechanism; and
operating the support mechanism according to the target control information at the time indicated by the time information.

19. The method of claim 18, further comprising:
controlling the support mechanism according to the target control information and a signal detected by a sensor detecting the vibration of the photographing device.

20. The method of claim 18, further comprising:
obtaining the time information from the photographing device.
